(19) United States
(12) Patent Application Publication
(10) Pub. No.: US 2004/0266913 A1
(43) Pub. Date: Dec. 30, 2004

(54) Cationic polymerizable adhesive composition and anisotropically electroconductive adhesive composition

(76) Inventors: Hiroaki Yamaguchi, Yamato, Kanagawa (JP); Yuji Hiroshige, Tokyo (JP); Ryota Akiyama, Sagamihara, Kanagawa (JP); Tetsu Kitamura, Kawasaki, Kanagawa (JP)

Correspondence Address: 3M INNOVATIVE PROPERTIES COMPANY, PO BOX 33427, ST. PAUL, MN, 55133-3427, US

(21) Appl. No.: 10/485,904

(22) PCT Filed: Jul. 19, 2002
(86) PCT No.: PCT/US02/22998

(30) Foreign Application Priority Data
Sep. 13, 2001 (JP) 2001/278507

(51) Int. Cl. C09J 4/00; C09J 101/00; C09J 201/00

(52) U.S. Cl. 523/176

(57) ABSTRACT

A cationic polymerizable adhesive composition comprising a cationic polymerizable monomer selected from an epoxy monomer, a vinyl ether monomer and a mixture thereof, a cationic polymerization catalyst and a stabilizer, wherein the stabilizer is at least one acid amide represented by the following Formula (I) wherein R¹ is an alkyl group having from 1 to 30 carbon atoms or an alkenyl group containing one or two unsaturated bond(s) and having from 2 to 30 carbon atoms, and each R² is independently hydrogen or an alkyl group having from 1 to 10 carbon atoms.

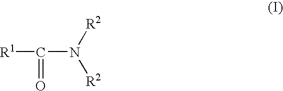

### DETAILED DESCRIPTION OF THE INVENTION

The present invention relates to a cationic polymerizable adhesive composition capable of exhibiting excellent adhesive strength, and an anisotropically electroconductive or heat-conductive adhesive composition capable of exhibiting good electrical or thermal conductivity and at the same time, excellent adhesive strength.

Cationic polymerizable compositions making use of cationic polymerization are being widely used, for example, in the field of coating material, ink and adhesive. Particularly in the use for an adhesive, the cationic polymerizable composition is advantageous because of its high curing rate and freeness of oxygen hindrance. However, the rapid curability of the cationic polymerizable composition incurs reduction of the adhesive strength in some cases. More specifically, if the adhesive composition is thoroughly coated and spread on an adherend and due to the rapid progress of reaction, is solidified before coming into contact with the adherend surface, a sufficiently high adhesive strength cannot be obtained. In order to solve this problem, it is effective to select a cationic polymerizable compound and a polymerization catalyst each having by itself low reactivity to an extent of not affecting the curability at a desired temperature or to add a stabilizer capable of inhibiting the polymerization to that extent to the adhesive composition. By these means, the storage stability of the cationic polymerizable composition is improved at the same time.

For example, Japanese Unexamined Patent Publication (Kokai) No. 4-227625 describes addition of a specific amine as a stabilizer to an epoxy resin composition comprising an epoxy resin and a specific iron-arene complex as an initiator, and states that by the addition of such an amine, even after the epoxy resin composition is activated by the light irradiation, the storage stability at room temperature is ensured over 30 days or more and the composition can be quickly cured at a high temperature.

Japanese Unexamined Patent Publication (Kohyo) No. 8-511572 describes an energy polymerizable composition comprising a cationic curable monomer, a salt of organic metal complex cation and a specific stabilizing additive, and states that by having such a construction, this composition is elevated in the storage stability and the pot life.

Japanese Unexamined Patent Publication (Kokai) No. 5-262815 describes a reactive composition containing a cationic polymerizable compound and a thermally latent catalyst comprising a complex of a Lewis acid and an electron-donating compound, and states that by having such a construction, the composition is elevated in the storage stability and gives a polymer having excellent physical properties.

On the other hand, in a liquid crystal display device, the electrode part of a glass-made display panel and a flexible circuit called TCP (tape carrier package) having mounted thereon a driving IC necessary for actuating the display panel are connected by the thermocompression bonding with the intervention of anisotropically electroconductive adhesive film. The connection pitch thereof is usually from 100 to 200 μm. However, as the display part becomes highly definite, the connection pitch becomes finer and in recent years, a connection pitch of 50 μm or less is demanded. This finer connection pitch causes a problem of pitch slippage by the expanding and shrinking behavior of TCP due to heat at the thermocompression bonding. In order to solve this problem, an anisotropically electroconductive adhesive film capable of thermocompression bonding at a lower temperature is being demanded. Furthermore, for improving the productivity, an anisotropically electroconductive adhesive film capable of thermocompression bonding within a shorter time is also being demanded. For the purpose of satisfying these requirements, an anisotropically electroconductive adhesive film using a cationic polymerization mechanism and having high reactivity has been proposed.

For example, Japanese Unexamined Patent Publication (Kohyo) No. 8-511570 describes an. anisotropically electroconductive adhesive composition comprising a curable epoxy resin, a thermoplastic resin, an organic metal complex cation, a stabilizing additive, a curing rate enhancer and electroconductive particles, and states that heat-curing at a temperature of from 120 to 125° C. can be attained.

### PROBLEMS TO BE SOLVED BY THE INVENTION

By the use of these stabilizers, the obtained adhesive composition is improved in the storage life and enables thermocompression bonding at a low temperature, however, the adhesive strength is not sufficiently high.

The object of the present invention is to provide a cationic polymerizable adhesive composition having a long storage life, capable of thermocompression bonding at a low temperature and ensuring excellent adhesive strength.

### MEANS TO SOLVE THE PROBLEMS

In order to solve the above-described problems, the present invention provides a cationic polymerizable adhesive composition comprising (A) a cationic polymerizable monomer selected from an epoxy monomer, a vinyl ether monomer and a mixture thereof, (B) a cationic polymerization catalyst and (C) a stabilizer, wherein at least one acid amide represented by the following formula (I):

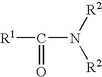

(wherein R¹ is an alkyl group having from 1 to 30 carbon atoms or an alkenyl group containing one or two unsaturated bond and having from 2 to 30 carbon atoms, and R² are independently hydrogen or an alkyl group having from 1 to 10 carbon atoms) is used as (C) the stabilizer.

According to the present invention, the above-described cationic polymerizable adhesive composition and an anisotropically electroconductive or heat-conductive adhesive composition comprising electroconductive or heat-conductive particles are provided.

### MODE FOR CARRYING OUT THE INVENTION

As described above, the cationic polymerizable adhesive composition of the present invention is constructed by (A) a cationic polymerizable monomer, (B) a cationic polymerization catalyst and (C) an acid amide represented by formula (1) as a stabilizer. Respective constituent components are described below.

Cationic Polymerizable Monomer

The cationic polymerizable monomer is selected from an epoxy monomer, a vinyl ether monomer and a mixture thereof. Examples of the epoxy monomer include 1,2-cyclic ether, 1,3-cyclic ether and 1,4-cyclic ether each having a cationic polymerizable functional group, however, the epoxy monomer is limited to monomers not having a group of inhibiting the cationic polymerization, for example, a functional group containing amine, sulfur or phosphorous. This epoxy monomer is preferably an alicyclic epoxy resin or a glycidyl group-containing epoxy resin.

The alicyclic epoxy resin is a compound having on average two or more alicyclic epoxy groups within the molecule and examples thereof include those having two epoxy groups within the molecule, such as vinylcyclohexene dioxide (e.g., ERL-4206, produced by Union Carbide Japan), 3,4-epoxycyclohexylmethyl-3,4-epoxycyclohexane carboxylate (e.g., UVR-6105 and UVR-6110, produced by Union Carbide Japan), bis(3,4-epoxycyclohexyl)adipate (e.g., UVR-6128, produced by Union Carbide Japan) and 2-(3,4-epoxycyclohexyl -5,5-spiro-3,4epoxy)cyclohexane-meta-dioxane (e.g., ERL-4234, produced by Union Carbide Japan), and polyfunctional alicyclic epoxy resins having 3, 4 or more epoxy groups within the molecule (e.g., Epolide GT, produced by Daicel Chemical Industries, Ltd.).

The alicyclic epoxy resin usually has an epoxy equivalent of 90 to 500, preferably from 100 to 400, more preferably from 120 to 300, most preferably from 210 to 235. If the epoxy equivalent is less than 90, the toughness after thermosetting and the adhesive strength may be reduced to cause decrease in the connection reliability, whereas if the epoxy equivalent exceeds 500, the viscosity of the entire system is excessively increased, as a result, poor flowability may be exhibited at the thermocompression bonding or the reactivity may be lowered, thereby reducing the connection reliability.

The glycidyl group-containing epoxy resin is a compound having on average two or more glycidyl groups within the molecule and examples thereof include bisphenol A-type glycidyl ether (e.g., Epikote 828, produced by Yuka Shell Epoxy) and phenol novolak-type epoxy (e.g., Epikote 154, produced by Yuka Shell Epoxy K.K.)

The glycidyl group-containing epoxy resin usually has an epoxy equivalent of 170 to 5,500, preferably from 170 to 1,000, more preferably from 170 to 500, most preferably from 175 to 210. If the epoxy equivalent is less than 170, the toughness after thermosetting and the adhesive strength may be lowered, whereas if the epoxy equivalent exceeds 5,500, the viscosity of the entire system is excessively increased, as a result, poor flowability may be exhibited at the thermocompression bonding or the reactivity may be lowered, thereby reducing the connection reliability.

The vinyl ether monomer has a high electron density of double bond and produces a very stable carbocation, therefore, this monomer has a high reactivity in the cationic polymerization. For not inhibiting the cationic polymerization, the vinyl ether monomer is limited to those not containing nitrogen and examples thereof include methyl vinyl ether, ethyl vinyl ether, tert-butyl vinyl ether, isobutyl vinyl ether, triethylene glycol divinyl ether and 1,4-cyclohexane dimethanol divinyl ether. Preferred examples of the vinyl ether monomer include triethylene glycol divinyl ether (e.g., Rapi-Cure DVE-3, produced by ISP Japan K.K.) and cyclohexane dimethanol divinyl ether (e.g., Rapi-Cure CHVE, produced by ISP Japan K.K.).

These epoxy monomers and vinyl ether monomers may be used individually or as a mixture thereof. A plurality of epoxy monomers or vinyl ether monomers may be used. Particularly, a mixture of an alicyclic epoxy resin and a glycidyl group-containing epoxy resin is preferably used. The alicyclic epoxy resin has an action of improving the rapid curability and low-temperature curability of the adhesive composition and because of its low viscosity, also has an action of elevating the adhesion of the adhesive composition to an adherend. On the other hand, the glycidyl group-containing epoxy resin has an action of prolonging the usable time of the adhesive composition after activation. Accordingly, by using the alicyclic epoxy resin and the glycidyl group-containing epoxy resin in combination, the obtained adhesive composition can exhibit in good balance both the low-temperature rapid curability of the alicyclic epoxy resin and the long storage stability at room temperature of the glycidyl group-containing epoxy resin. The ratio of the alicyclic epoxy resin/glycidyl group-containing epoxy resin blended is usually 5:95 to 98:2, preferably 40:60 to 94:6, more preferably 50:50 to 90:10, most preferably 50:50 to 80:20. If the amount of the alicyclic epoxy resin is less than 5% by weight based on the total amount of the alicyclic epoxy resin and the glycidyl group-containing epoxy resin, the curing properties at low temperatures may be reduced to fail in providing sufficiently high adhesive strength or connection reliability, whereas if the amount of the alicyclic epoxy resin exceeds 98% by weight, a curing reaction readily proceeds even at near room temperature and therefore, the usable time after activation may be shortened. The amount of the cationic polymerizable monomer blended is preferably from 10 to 90 parts per 100 parts by weight of the entire composition.

Cationic Polymerization Catalyst

The cationic polymerization catalyst is a compound of producing a cationic active species such as Lewis acid upon irradiation with ultraviolet rays or under heating and catalyzing an ring-opening reaction of the epoxy ring. Examples of this cationic polymerization catalyst include aryldiazonium salts, diaryliodonium salts, triarylsulfonium salts, triarylselenium salts and iron-arene complexes. Among these, iron-arene complexes are particularly preferred because of their thermal stability, and specific examples thereof include xylene-cyclopentadienyl iron(II) (tris(trifluoromethylsulfonyl)methide, cumene-cyclopentadienyl iron(II) hexafluorophosphate and bis(etha-mesithylene) iron(II) tris(trifluoromethylsulfonyl)methide. The other examples of cationic polymerization catalyst are disclosed in Japanese Unexamined Patent Publication No. 8-511572.

The amount of the cationic polymerization catalyst used is usually from 0.05 to 10.0 parts by weight, preferably from 0.075 to 7.0 parts by weight, more preferably from 0.1 to 4.0 parts by weight, most preferably from 1.0 to 2.5 parts by weight, per 100 parts by weight of the cationic polymerizable monomer. If the amount used is less than 0.05 parts by weight, the curing properties at low temperatures may be lowered to fail in providing sufficiently high adhesive strength or connection reliability, whereas if it exceeds 10.0 parts by weight, a curing reaction readily proceeds even at near room temperature and therefore, the storage stability at room temperature may decrease.

Stabilizer

The stabilizer has an action of effectively controlling the curing rate of the adhesive composition of the present invention. In the present invention, the stabilizer is an acid amide having a structure where a hydrogen of ammonia or amine is displaced by an acyl group, as shown in the above formula (I).

Specific examples of the acid amide include acetamide, propionamide, n-butyramide, lauramide, N,N-dimethylacetamide, oleamide and erucamide.

The amount of the stabilizer blended is preferably from 0.000005 to 0.02 parts per 100 parts by weight of the entire adhesive composition. The equivalent of the stabilizer to the cationic polymerization catalyst is preferably 0.03 to 1.0. If the amount blended is less than 0.03, the effect as a stabilizer cannot be expected, whereas if it exceeds 1.0, the adhesive property to an adherend may be poor. The equivalent is preferably from 0.05 to 0.8, more preferably from 0.1 to 0.5.

By mixing these cationic polymerizable monomer, cationic polymerization catalyst and stabilizer, the cationic polymerizable adhesive composition of the present invention can be obtained. The anisotropically electroconductive adhesive composition can be obtained by adding electroconductive particles to this adhesive composition and the heat-conductive adhesive composition can be obtained by adding heat-conductive particles.

Examples of the electroconductive particle which can be used include electroconductive particles such as carbon particle and metal particle of copper, nickel, gold, tin, zinc, platinum, palladium, iron, tungsten, molybdenum, solder or the like. These particles may also be used after further covering the particle surface with an electroconductive coating of a metal or the like. Furthermore, non-electroconductive particles of glass bead, silica, graphite, ceramic or a polymer such as polyethylene, polystyrene, phenol resin, epoxy resin, acryl resin and benzoguanamine resin, of which surface is covered with an electroconductive coating of a metal or the like, may also be used. The shape of the electroconductive particle is not particularly limited but a nearly spherical shape is usually preferred. This particle may have a slightly rough or spiked surface. The shape may also be either ellipsoidal or long cylindrical.

The average particle size of the electroconductive particles used may vary depending on the width of electrode used for connection and the spacing between adjacent electrodes. For example, in the case where the electrode width is 50 μm and the spacing between adjacent electrodes is 50 μm (namely, the electrode pitch is 100 μm), the average particle size is suitably on the order of 3 to 20 μm. By using an anisotropically electroconductive adhesive film having dispersed therein electroconductive particles having an average particle size within this range, sufficiently good electroconductive characteristics can be attained and at the same time, short circuiting between adjacent electrodes can be satisfactorily prevented. Since the pitch of electrodes used for connection of circuit substrates with each other is usually from 50 to 1,000 μm, the average particle size of the electroconductive particles is preferably from 2 to 40 μm. If the average particle size is less than 2 μm, the particles are buried in pits on the electrode surface and may not function as an electroconductive particle, whereas if it exceeds 40 μm, short circuiting is readily generated between adjacent electrodes.

The amount of the electroconductive particles added may be varied depending on the area of electrode used and the average particle size of electroconductive particles. A satisfactory connection is usually attained when a few (for example, from 2 to 10) electroconductive particles are present per electrode. In the case of more reducing the electrical resistance, the electroconductive particles may be blended in the adhesive such that from 10 to 300 electroconductive particles are present. Furthermore, in the case where a high pressure is imposed at the time of thermocompression bonding, the number of electroconductive particles on electrode may be increased to 300 to 1,000 to disperse the pressure and thereby achieve a satisfactory connection. The amount of electroconductive particles is usually from 0.1 to 30% by volume, preferably from 0.5 to 10% by volume, more preferably from 1 to 5% by volume, based on the total volume of the adhesive excluding the electroconductive particles. If the amount is less than 0.1% by volume, electroconductive particles are highly probably absent on the electrode at the time of bonding and the connection reliability may decrease, whereas if the amount exceeds 30% by volume, short circuiting is readily generated between adjacent electrodes.

The heat-conductive adhesive composition obtained by adding heat-conductive particles to the cationic polymerizable adhesive composition of the present invention is used for a heat source, for example, between an electron part and a heat sink or between the electron part and a circuit substrate, and serves as a heat transfer interface upon thermal distribution of a heat source. Examples of the heat-conductive particle which can be used include particles of alumina, silica, boron nitride, magnesium oxide and carbon fiber. The shape of the heat-conductive particle is not limited to the particle form but various shapes such as plate and needle may be used. The heat-conductive particle preferably has a size of 0.1 μm to 500 μm in view of the use thereof. Heat-conductive particles having different sizes may also be used in combination. The ratio of the heat-conductive particles to 100 parts by weight of the adhesive composition is preferably 100 to 1000 parts.

The anisotropically electroconductive or heat-conductive adhesive composition is preferably used in the form of a film. The film can be obtained by preparing a coating solution containing the adhesive composition in an appropriate organic solvent such as methylethylketone (MEK), applying the coating solution onto a separator using appropriate coating means such as knife coater, and drying the coating film. At this time, a release layer may be formed of a silicon-based or fluorine-based release agent on one surface or both surfaces of the separator. In the case of using an ultraviolet activation-type polymerization catalyst as a cationic polymerization catalyst, the film can be obtained by the heat-melting and extrusion-molding of the adhesive composition in addition to the above-described film formation using an organic solvent. The ultraviolet activation-type cationic polymerization catalyst is thermally very stable unless ultraviolet rays are irradiated thereon and hardly undertakes a reaction even at a temperature of 100° C. or more with a time period from several minutes to several hours. The thickness of the thus-formed film is preferably from 5 to 100 μm so as to attain necessary and satisfactory filing without allowing the presence of a gap in the connection part upon connecting circuit substrates with each other by thermocompression bonding.

The cationic polymerizable adhesive composition of the present invention may contain other additives according to the end use in addition to the above-described components. Examples of the additives which can be added to the adhesive compositions include a cationic polymerization accelerator (for example, di-tert-butyl oxalate), an antioxidant (for example, hindered phenol-based antioxidant), a diol (for example, bis(phenoxyethanol)fluorene), a coupling agent (for example, a silane coupling agent such as γ-glycidoxypropyl trimethoxysilane and β-(3,4-epoxycyclohexyl)ethyl trimethoxysilane), a chain transfer agent, a sensitizer (for example, anthracene), a tackifier, a thermoplastic elastomer or resin, a filler (for example, silica), a flow adjusting agent, a plasticizer, an antifoaming agent and colorant. Furthermore, a stabilizer excluding an acid amide may also be added. Examples thereof include a stabilizer which suppresses or inhibits the cationic polymerization reaction by trapping the Lewis acid or the like serving as a cationic active seed in the cationic polymerization, and specific examples thereof include crown ethers such as 15-crown-5, 1,10-phenanthroline and derivatives thereof, toluidines such as NN-diethyl-meta-toluidine, phosphines such as triphenylphosphine, and triazines.

The thermoplastic elastomer or resin is preferably incorporated when the cationic polymerizable adhesive composition of the present invention is formed into an adhesive film. The thermoplastic elastomer or resin increases the film formability of the adhesive film and at the same time, improves the impact resistance of the adhesive film, relaxes the residual internal stress generated by the curing reaction and elevates the bonding reliability. The thermoplastic elastomer is one kind of polymer compounds commonly called a thermoplastic elastomer, which are composed of a hard segment as a confined phase and a soft segment expressing rubber elasticity, at a certain temperature or less. Example of this elastomer include a styrene-based thermoplastic elastomer. The styrene-based elastomer is a block copolymer containing, for example, a styrene unit in the hard segment and a polybutadiene or polyisoprene unit in the soft segment. Typical examples thereof include a styrene-butadiene-styrene block copolymer (SBS) and a styrene-isoprene-styrene block copolymer (SIS) and additionally include a styrene-(ethylene-butylene)-styrene block copolymer (SEBS) and a styrene-(ethylene-propylene)-styrene block copolymer (SEPS), where the diene component in the soft segment is hydrogenated. Furthermore, styrene-based thermoplastic elastomers having a reactive group, such as elastomer epoxy-modified by glycidyl methacrylate and elastomer in which the unsaturated bond of conjugate diene is epoxidized, may also be used. The elastomer having a reactive group is elevated in the compatibility with the epoxy resin because of high polarity of the reactive group and therefore, broadened in the latitude of blending with epoxy resin and at the same time, since the reactive group is incorporated into the crosslinked structure by the crosslinking reaction with epoxy resin, the resistance against heat and humidity after the curing is ensured and thereby the bonding reliability can be improved. Examples of the epoxidized styrene-based elastomer include Epofriend A1020 (produced by Daicel Chemical Industries, Ltd.). In the present invention, a thermoplastic resin may also be used in place of the thermoplastic elastomer. The adhesive must be eliminated by fluidization at the thermocompression bonding of the adhesive film, so that good electrical connection can be attained between circuits on the bonded substrates. Therefore, the thermoplastic resin preferably has a Tg of the thermocompression bonding temperature (for example, from 100 to 130° C.) or less. Examples of this thermoplastic resin include polystyrene resin, acrylic resin, phenoxy resin and a combination thereof

The amount of the thermoplastic elastomer or resin is usually from 10 to 900 parts by weight, preferably from 20 to 500 parts by weight, more preferably from 30 to 200 parts by weight, most preferably from 40 to 100 parts by weight, per 100 parts by weight of the cationic polymerizable monomer. If the amount is less than 10 parts by weight, the adhesive composition may be reduced in the film formability, whereas if the amount exceeds 900 parts by weight, the adhesive composition as a whole is reduced in the flowability at low temperatures and poor contact results between the electroconductive particles and the circuit substrate at the bonding, causing increase in the electrical resistance or reduction in the connection reliability and sometimes also decrease in the bonding strength.

In the case of the cationic polymerizable adhesive composition, anisotropically electroconductive adhesive composition or heat-conductive adhesive composition of the present invention containing the above-described components being, for example in the form of an adhesive film, after disposing the film on a substrate (pre-bonding), the other substrate to be bonded is thermocompression-bonded onto the adhesive composition by a press-bonding head (final-bonding), whereby two substrates are bonded. In the case of the cationic polymerization catalyst being ultra-violet activatable cationic polymerization catalyst, it is necessary to activate the adhesive composition by radiating ultra-violet ray at least before final-bonding.

The repairing of the substrates, particularly circuit substrates bonded using a conventional adhesive composition, more specifically, the operation of separating the circuit substrates at the connection part and removing the adhesive residue on one or both of the circuit substrates, is performed using an organic solvent as follows. The circuit substrate connection part is heated at 100 to 180° C. for 5 to 10 seconds using a laminator, namely, a so-called heat generator such as iron, compressor and drier. One circuit substrate is peeled off while the circuit substrates are hot. Subsequently, the surface of the separated circuit substrate is strongly rubbed for 30 to 60 seconds using a cotton swab wetted with an organic solvent such as acetone, toluene or methylethylketone (MEK) to remove the adhesive residue. The surface of the circuit substrate is again washed by a cotton swab wetted with an organic solvent. At this time, it is necessary to take care not to contact the organic solvent with the adjacent circuit connection part.

However, in the case of using the cationic polymerizable adhesive composition of the present invention, the circuit substrates can be repaired without using an organic solvent. For example, two circuit substrates bonded by thermo-compression using the anisotropically electroconductive adhesive composition of the present invention are heated to an appropriate temperature within the range from 100 to 250° C. and a force for separating the circuit substrates from each other is applied thereto, whereby two circuit substrates are separated without seriously impairing the circuit substrates. In the case where the anisotropically electroconductive adhesive composition remains on the circuit substrate, the residue still in the heated state can be further mechanically scrubbed out using a tool constructed by, at least in the distal end part, wood, paper or a polymer or metal which does not melt at the temperature used. For repairing the connection part between a flex circuit and a glass circuit of a liquid panel, a method of abutting an instrument working out to a heat source, such as a thermocompressor head, from the flex circuit side or a method of placing the glass circuit on a hot plate and heating the circuit, may be used.

The cationic polymerizable adhesive composition of the present invention is characterized also in that the composition is highly stable in the state of a solution prepared, for example, in the case of forming an adhesive film. In general, when the produced cationic polymerizable composition has high reactivity, the solution thereof must be handled with thorough care, for example, by adjusting the temperature so as not to cause an explosion reaction and thereby solidify the solution. However, the composition of the present invention contains a small amount of an acid amide and the acid amide acts as a polymerization inhibitor of the solution, so that the solution can be prevented from solidifying.

### EXAMPLES

Production of Anisotropically Electroconductive Adhesive Film

1.0 g of alicyclic epoxy resin (Cyracure UVR6128, trade name, produced by Union Carbide Japan Ltd., epoxy equivalent: 200), 5.0 g of glycidyl group-containing phenol-novolak epoxy resin (Epikote 154, trade name, produced by Yuka Shell Epoxy Ltd., epoxy equivalent: 178), 4.0 g of phenoxy resin (PKHC, produced by Phenoxy Associates Ltd., OH equivalent: 284) and an acid amide in a predetermined equivalent weight to the catalyst, shown in Table 1 (Example 1: oleic amide (molecular weight: 281); Example 2: erucic amide (molecular weight: 338; Example 3: lauric acid amide (molecular weight: 73); Example 4: n-butyric acid amide (molecular weight: 87)) were mixed with 10 g of methyl ethyl ketone and the mixture was stirred until a uniform solution was formed. Thereto, electroconductive particles (particles obtained by providing a nickel layer on the surface of a divinylbenzene copolymer and further stacking gold thereon, average particle size: 5 μm) were added to occupy 3% by volume in the final solid and continuously stirred until the electroconductive particles were thoroughly dispersed. Separately, 0.060 g of cationic polymerization catalyst (bis(eta-mesitylene) iron(II)-tris(trifluoromethylsulfonyl)methide), 0.009 g of stabilizer (N,N-diethyl-m-toluidine), 0.2 g of silane coupling agent (Silane Coupling Agent A187, produced by Nippon Unicar Co., Ltd., γ-glycidoxypropyl trimethoxysilane) and 0.6 g of methyl ethyl ketone were mixed and stirred until a uniform solution was formed, and this solution was added to the dispersion solution prepared above, followed by further stirring. The thus-obtained dispersion solution of the anisotropically electroconductive adhesive composition was applied onto a silicone-treated polyester film as a separator, using a knife coater and then dried at 60° C. for 10 minutes to obtain an anisotropically electroconductive adhesive film having a thickness of 20 μm (E1 to 4).

Furthermore, 4.0 g of glycidyl group-containing bisphenol A-type epoxy resin (Epikote YL980, trade name of Yuka Shell Epoxy Ltd., epoxy equivalent: 189), 2.0 g of glycidyl group-containing phenol-novolak epoxy resin (Epikote 154, trade name of Yuka Shell Epoxy Ltd., epoxy equivalent: 178), 4.0 g of phenoxy resin (PKHC, produced by Phenoxy Associates Ltd., OH equivalent: 284) and an acid amide in a predetermined equivalent weight to the catalyst, shown in Table 2 (oleic acid amide (molecular weight: 281)) were mixed with 10 g of methyl ethyl ketone and the mixture was stirred until a uniform solution was formed. Thereafter, the solution was processed in the same manner as above to obtain an anisotropically electroconductive adhesive film having a thickness of 20 μm (E5 and E6).

For the purpose of comparison, anisotropically electroconductive adhesive films were produced in the same manner as in E1 except for omitting acid amide (C1) or in the same manner as in E5 except for changing the amount of acid amide to 1 equivalent to the catalyst (C2 and C3) or omitting acid amide (C4).

The thus-produced anisotropically electroconductive adhesive films having a width of 2 mm and a length of 4 cm each was tacked onto a 0.7 mm-thick glass plate with ITO (indium tin oxide) film and bonded by thermocompression at 60° C. and a pressure of 1.0 MPa for 4 seconds and then, the separator polyester film was peeled off (pre-bonding). Thereafter, a flexible circuit comprising a 25 μm-thick polyimide film having disposed thereon gold-plate copper traces to a conductor pitch of 70 μm, a conductor width of 35 μm and a thickness of 12 μm was positioned and fixed on the anisotropically electroconductive adhesive film pre-bonded above. These were heat-pressed using an ordinarily heating-type compressor under the conditions such that the anisotropically electroconductive adhesive film portion was heated at 180° C. and 2.0 MPa for 8 to 10 seconds, thereby completing the circuit connection (main bonding).

Evaluation of Adhesive Strength

The flexible circuit thus-formed by the thermocompression bonding onto a glass plate with ITO film was cut into a width of 5 mm and pulled in the direction of 90° from the glass plate with ITO film at a rate of 50 mm/minute and the maximum value thereof was recorded.

Evaluation of Exothermic Property by DSC (Differential Scanning Calorimeter)

If an acid amide excessively inhibits the polymerization reaction of epoxy, the polymerization reaction does not satisfactorily proceed and in the measurement by DSC, this appears as an increase of exotherm peak temperature or a decrease of the heating value. Accordingly, the exotherm energy was measured in the range from 50 to 200° C. and the obtained values were compared with the case where an acid amide was absent. At the measurement, the temperature-elevating rate was set to 10° C/minute.

Evaluation of Connection State

The connection resistance between the glass plate with ITO film and the flexible circuit was measured using a digital multi-meter.

The evaluation results are shown in Table 1 and Table 2.

TABLE 1

| | Example | | | | Comparative Examples | | |
|---|---|---|---|---|---|---|---|
| Composition | E1 | E2 | E3 | E4 | C1 | C2 | C3 |
| UVR6128 | 1 | 1 | 1 | 1 | 1 | 1 | 1 |
| Epikote 154 | 5 | 5 | 5 | 5 | 5 | 5 | 5 |
| PKHC | 4 | 4 | 4 | 4 | 4 | 4 | 4 |
| Stabilizer | 0.009 | 0.009 | 0.009 | 0.009 | 0.009 | 0.009 | 0.009 |
| Silane coupling | 0.2 | 0.2 | 0.2 | 0.2 | 0.2 | 0.2 | 0.2 |
| agent A187 | | | | | | | |
| Cationic | 0.06 | 0.06 | 0.06 | 0.06 | 0.06 | 0.06 | 0.06 |
| polymerization | | | | | | | |
| catalyst | | | | | | | |
| Acid amide | oleic | erucic | lauric acid | n-butyr- | none | oleic | erucic |
| (equivalent to | amide, | amide, | amide, | amide, | | amide, | amide, |
| catalyst) | 0.0015 | 0.0018 | 0.0011 | 0.0005 | | 0.015 | 0.018 |
| | (0.1) | (0.1) | (0.1) | (0.1) | | (1) | (1) |
| Onset | 97 | 100 | 99 | 100 | 102 | 95 | 99 |
| temperature (° C.) | | | | | | | |
| DSC Exotherm | 108 | 108 | 108 | 108 | 105 | 105 | 108 |
| peak temperature | | | | | | | |
| (° C.) | | | | | | | |
| DSC Exotherm | 287 | 298 | 298 | 298 | 299 | 68 | 83 |
| energy (cal/g) | | | | | | | |
| Connection | 1.8 | 2.0 | 1.6 | 1.7 | 2.2 | 1.8 | 2.2 |
| resistance (Ω) | | | | | | | |
| Average adhesive | 663 | 698 | 707 | 679 | 503 | 586 | 705 |
| strength (N/m) | | | | | | | |
| Failure mode | cohesion | cohesion | cohesion | cohesion | ITO | ITO | ITO |
| | | | | | interface | interface | interface |

TABLE 2

| | | | Comparative |
|---|---|---|---|
| | Example | | Example |
| Composition | E5 | E6 | C4 |
| UVR6128 | 4 | 4 | 4 |
| Epikote 154 | 2 | 2 | 2 |
| PKHC | 4 | 4 | 4 |
| Stabilizer | 0.009 | 0.009 | 0.009 |
| Silane coupling agent A187 | 0.2 | 0.2 | 0.2 |
| Cationic polymerization | 0.06 | 0.06 | 0.06 |
| catalyst | | | |
| Acid amide | oleic amide, | oleic amide, | none |
| (equivalent to catalyst) | 0.0015 | 0.0045 | |
| | (0.1) | (0.3) | |
| Onset temperature (° C.) | 94 | 101 | 96 |
| DSC Exotherm peak | 122 | 128 | 121 |
| temperature (° C.) | | | |
| DSC Exotherm | 297 | 292 | 307 |
| energy (cal/g) | | | |
| Connection resistance (Ω) | 1.5 | 1.6 | 1.6 |
| Average adhesive | 690 | 590 | 632 |
| strength (N/m) | | | |
| Failure mode | cohesion | cohesion | ITO interface |

It is apparent from the Tables above that in Examples of the present invention, the measurement by the differential scanning calorimeter revealed neither decrease in the exotherm energy nor difference in the exotherm peak temperature, as compared with the case where an acid amide was not added (C1). From this, it is verified that the addition of an appropriate amount of an acid amide does not affect the curing reaction of the adhesive composition. The connection resistance and the peel adhesive strength were satisfied both in Examples and Comparative Examples, however, there was difference in the failure mode. More specifically, in any of Comparative Examples, the mode was interface failure between the ITO surface and the adhesive but in any of Examples where an appropriate amount of an acid amide was added, the mode was cohesive failure of the adhesive, revealing good adhesion at the interface.

### Effects of the Invention

As verified in the foregoing pages, the cationic polymerizable adhesive composition of the present invention has excellent adhesive property, particularly adhesive property at the interface between adhesive and adherend. Furthermore, when bonded using the cationic polymerizable adhesive composition of the present invention, the adhesive can be easily removed from the adherend without using an organic solvent at the time of repairing.

1-9. (cancelled)

10. A cationic polymerizable adhesive composition comprising:
(A) a cationic polymerizable monomer selected from an epoxy monomer, a vinyl ether monomer, and a mixture thereof;
(B) a cationic polymerization catalyst; and
(C) a stabilizer,
wherein said stabilizer (C) is at least one acid amide represented by the following Formula (I): 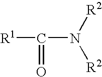
wherein R¹ is an alkyl group having from 1 to 30 carbon atoms or an alkenyl group containing one or two unsaturated bond(s) and having from 2 to 30 carbon atoms, and each R² is independently hydrogen or an alkyl group having from 1 to 10 carbon atoms; and
(D) electroconductive particles or heat-conductive particles.

11. The cationic polymerizable adhesive composition of claim 10, wherein said acid amide is selected from acetamide, propionamide, n-butyramide, lauric acid amide, N,N-dimethylacetamide, oleic amide, erucic amide and a mixture thereof.

12. The cationic polymerizable adhesive composition of claim 10, wherein said acid amide is selected from acetamide, propionamide, n-butyramide, lauric acid amide, oleic amide, erucic amide and a mixture thereof.

13. The cationic polymerizable adhesive composition of claim 10, wherein the amount of said acid amide blended is from 0.000005 to 0.02 parts per 100 parts by weight of the entire adhesive composition.

14. The cationic polymerizable adhesive composition of claim 10, wherein said cationic polymerizable monomer is an alicyclic epoxy resin, a glycidyl group-containing epoxy resin or a mixture thereof.

15. The cationic polymerizable adhesive composition of claim 10, wherein said cationic polymerization catalyst is a thermal activation-type cationic polymerization catalyst.

16. Adhesive composition of claim 10, which is in the form of a film.

17. A cationic polymerizable adhesive composition comprising:
(A) a cationic polymerizable monomer selected from an epoxy monomer, a vinyl ether monomer, and a mixture thereof;
(B) a cationic polymerization catalyst;
(C) a stabilizer,
wherein said stabilizer (C) is at least one acid amide represented by the following Formula (I): 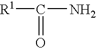
wherein R¹ is an alkyl group having from 1 to 30 carbon atoms or an alkenyl group containing one or two unsaturated bond(s) and having from 2 to 30 carbon atoms.

18. The cationic polymerizable adhesive composition of claim 17, wherein the amount of said acid amide blended is from 0.000005 to 0.02 parts per 100 parts by weight of the entire adhesive composition.

19. The cationic polymerizable adhesive composition of claim 17, wherein said cationic polymerizable monomer is an alicyclic epoxy resin, a glycidyl group-containing epoxy resin or a mixture thereof.

20. The cationic polymerizable adhesive composition of claim 17, wherein said cationic polymerization catalyst is a thermal activation-type cationic polymerization catalyst.

21. Adhesive composition as of claim 17, which is in the form of a film.
